(19) United States
(12) Patent Application Publication
(10) Pub. No.: US 2009/0310125 A1
(43) Pub. Date: Dec. 17, 2009

(54) Arrangement Adapted to Evaluate the Intensity of or a Changing in the Intensity of an Electro-Magnetic Beam or a Bundle of Beams

(76) Inventors: Thomas Jeff Adamo, New York, NY (US); Lars Montelius, Bjarred (SE)

Correspondence Address: LEVISOHN, BERGER , LLP, 11 BROADWAY , Suite 615, NEW YORK, NY, 10004, US

(21) Appl. No.: 12/066,981

(22) PCT Filed: Sep. 14, 2006
(86) PCT No.: PCT/SE2006/001046

§ 371 Date: Jun. 4, 2008

(30) Foreign Application Priority Data
Sep. 16, 2005 (SE) 0502053-2

(51) Int. Cl. G01N 21/59; G01J 1/00

(52) U.S. Cl. 356/51; 356/432

(57) ABSTRACT

The present invention refers to an arrangement adapted to evaluate the spectral intensity of and/or a changing in the spectral intensity of an electro-magnetic beam or a bundle of beams, whereby said bundle of beams is directed towards and received by a lens element and where said lens element is adapted to direct said bundle of beams towards a multitude of electro-magnetic beam to an electric signal transforming means, named as an opto-electric transforming means, said means adapted to generate an electric signal representative to said spectral intensity of or said changing in said spectral intensity of said beam. The invention suggests that a multitude of lens elements shall expose dimensions adapted within a sub-micron scale (10⁻⁶ m) and that at least one of said opto-electric transforming means, preferably a multitude of said means, is arranged adjacent to said lens element.

### TECHNICAL FIELD OF THE INVENTION

The present invention discloses generally an arrangement, adapted to evaluate the intensity of or a changing in the intensity of an electro-magnetic beam or a bundle of especially light beams, falling within visible or un-visible wave-lengths.

More especially the present invention refers to an arrangement adapted to evaluate an intensity of and/or a changing in the intensity of an electro-magnetic beam or bundle of beams, whereby said bundle of beams is directed towards and received by a lens element and where said lens element is adapted to direct, usually direct said bundle of beams in a converging manner, towards a multitude of electro-magnetic beams to its electric signal transforming means, in the following description indicated as an opto-electric transforming means, each of said means adapted to generate or transform an electric signal representative to said intensity of or said changing in said intensity of said beam.

The present invention is intended to be used within a wide area of technical applications, however the description below is restricted to only a few of these, only for a simplification reason, namely a sensor and a camera equipment.

It is also to be noted that the present invention is to be considered as a further development of the invention as it is shown and described in the PCT application, allotted the Serial Number PCT/US2005/008727, and its printed publication WO-A2-2005/089369.

The description of this application is to be considered as a part of this application.

### BACKGROUND OF THE INVENTION

Several different methods and systems of the aforesaid nature are known to the art.

For sensor applications and for digital camera applications it is previously known different kinds of arrangements adapted to evaluate the spectral intensity of and/or a changing in the spectral intensity of an electro-magnetic beam or a bundle of beams, whereby said bundle of beams is directed towards and received by a lens element.

Said element is adapted to direct said bundle of beams towards a multitude of electro-magnetic beam to an electric signal, transforming means of a known design and normally described as “pickles”.

This means is in the following description named as an “opto-electric transforming means”.

Said opto-electric transforming means is adapted to generate an electric signal, representative to said spectral intensity of or said changing in said spectral intensity of said beam, depending upon the criteria used for sensing and trigging circuit arrangements.

It is within the technical area of different sensors previously known to use different kinds of optical elements and/or lenses using radiation sensitive layers and when his layer is exposed for a light intensity, each of said opto-electric transferring means is generating an electric out-put signal, which can be monitored or sensed to activate a display informing unit via said circuit arrangements.

In digital cameras one or more lens elements are used to focus and to define the image onto a focal plane, where a light sensitive device, i.e. usually a CCD-plate, is situated.

It is also previously known to arrange on top of a light sensitive device a micro lens, in order to harvest as much light as possible to the used individual light sensitive components.

Considering the steps taken and related to the present invention it must be mentioned the following patent publications;
U.S. Pat. No. 6,765,617

This publication discloses an opto-electronic camera comprising an optical objective system for imaging a scene recorded by the camera as an optical image substantially in an image plane of the objective system, an opto-electronic detector device substantially provided in the image plane for detecting the optical image and on basis of the detection outputting output signals.

A processor device is connected with the detector device for converting and processing the output signals of the detector device in order to reproduce the detected image in digital form and possibly for displaying this in real time on a display device optionally provided in the camera and connected with the processor device.

A memory device is connected with the processor device for storing the digital image for displaying on the optional display device which also may be connected with the memory device, or for storing, displaying or possible additional processing on external devices adapted for these purposes and whereto the camera temporarily or permanently is connected.

It is further disclosed an opto-electronic camera, particularly for recording colour images and even more particularly for recording colour images in an RGB system, comprising an optical objective system for imaging a scene recorded by the camera as an optical image substantially in an image plane of the objective system.

An opto-electronic detector device is substantially provided in the image plane for detecting the optical image and on basis of the detection outputting output signals.

A processor device is connected with the detector device for converting and processing the output signals of the detector device in order to reproduce the detected image in digital form and possibly for displaying this in real time on a display device optionally provided in the camera and connected with the processor device.

A memory device is connected with the processor device for storing the digital image for displaying on the optional display device which also may be connected with the memory device, or for storing, displaying or possible additional processing on external devices adapted for these purposes and whereto the camera temporarily or permanently is connected.

This publication is concentrated to provide an opto-electronic camera which may be used for recording still images, cinematographic images or video images with high image quality and beyond all with high spatial resolution, while the total profile of the camera appears as very flat and the drawbacks which are linked with the prior art are avoided, and then particularly that the image resolution scales with the physical size, particularly the axial length of the optical imaging system.

This opto-electronic camera may be realized as a relatively thin layer, typically in the size range of 1-3 mm thickness on flat or curved surfaces.

Further, it is provided an opto-electronic camera with a number of specific spatial and spectral imaging characteristics, including controlled resolution of the optical image in one or more areas in the image or along one or more axes in the image plane, an extremely large field of view, including up to a global field (4π steradians), spatially resolved chromatic or spectral analysis, full-colour images or imaging in one or more wavelength bands from ultraviolet to infrared and parallaxis-based imaging with the possibility of spatial detection and analysis.

An opto-electronic camera offers imaging solutions which exploit light-detecting elements and circuits realized in optoelectronic technology on large surfaces.

Such technology will allow an opto-electronic camera to be manufactured with particular low cost.

This opto-electronic camera shall be realized with the use of thin devices based on amorphous or polycrystalline inorganic semiconductors or organic semiconductors based on polymers or oligomers. An example of the application of such material shall be components in the form of flexible plastic sheets, realized as thin cards which may be attached to flat and curved surfaces.

It is here to realize ultraminiaturized opto-electronic cameras by using arrays of quasi-monochromatic microlenses as the optical active structures in the camera.
US-A1-2005/0052751

This patent publication discloses an optical system that includes an array of opto-electronic devices, an array of micro lenses, and a fore optic.

The array of opto-electronic devices lie substantially along a plane, but the fore optic has a non-planar focal field.

To compensate for the non-planar focal field of the fore optic, each opto-electronic device has a corresponding micro lens.

Each micro lens has a focal length and/or separation distance between it and its respective opto-electronic device, which compensates for the non-planar focal field of the fore optic.

The focal lengths of these lenses may differ relative to one another. As a result, light that is provided by the fore optic is reconfigured by the micro lenses having various focal lengths to be substantially focused along the plane of the array of opto-electronic devices.

Various arrangements of micro lenses, placing lenses on standoffs or posts, forming of optical waveguides, lens fabrication, wafer integration of micro-optics, and optical coupling may be used.

### Related International Patent Application

PCT/US2005/008727

This patent publication discloses an imaging system or camera system consisting of multiple nano-sized optical elements, arranged in an array format, with more than one pixel per optical element will have a higher resolution than each element would be capable of individually, since each element being at a different point gathers slightly different overlapping information.

Hence by processing such information one can obtain a clear image.

Furthermore, multiple information from sectors of an array of sensors can be processed to obtain 3-D, stereotypic and panoramic imaging and may be connected to each other allowing seeing around obstacles as well as enabling full 3-D tracking and/or metric determination of an unknown object.

Colour/spectroscopic imaging can be achieved by utilizing equally sized lenses and multi-wavelength sensing layers below the lenses.

However, colour/spectroscopic imaging and/or spectroscopy can be achieved by taking advantage of unique optical properties of nano-scaled lenses, accepting various wavelengths below their diffraction limits.

### SUMMARY OF THE PRESENT INVENTION

### Technical Problems

When taking into consideration the technical deliberations that a person skilled in this particular art must make in order to provide a solution to one or more technical problems that he/she encounters it will be seen on the one hand necessary initially to realize the measures and/or the sequence of measures that must be undertaken to this end and on the other hand to realize which means is/are required in solving one or more of said problems. On this basis it will be evident that the technical problems listed below, are highly relevant to the development of the present invention.

When considering the present standpoint of techniques, as described above, it will be seen that a technical problem exists in the ability to realize the significance of, the advantages associated with and/or the technical measures that will be required with respect of an arrangement, adapted to evaluate the spectral intensity of and/or a changing in the spectral intensity of an electro-magnetic beam or a bundle of beams, whereby said bundle of beams is directed towards and received by a lens element and where said lens element is adapted to direct said bundle of beams towards a multitude of electro-magnetic beam to an electric signal transforming means, named as opto-electric transforming means, said means are adapted to generate an electric signal representative to said spectral intensity of or said changing in said spectral intensity of said beam, where said arrangement may be used as a sensor, sensitive to a light beam or bundle of beams but also as a digital camera.

It will be seen as a technical problem to realize the significance of, the advantages associated with and/or the technical measures that will be required with respect to the arrangement incorporating means for reducing the dimensions and to achieve a higher degree of precision.

It will be seen as a technical problem to realize the significance of, the advantages associated with and/or the technical measures that will be required with respect to the arrangement incorporating a multitude, adjacent one another oriented, of lens elements, each exposing dimensions adapted within a sub-micron scale (less than 10⁻⁶ m) and that at least one of said opto-electric transforming means is arranged adjacent to one of said lens element.

It will be seen as a technical problem to realize the significance of, the advantages associated with and/or the technical measures that will be required with respect to the arrangement incorporating said electro-magnetic beam or bundle of beams to be adapted to be used in a sensor equipment as well as in a photographic camera equipment or technology.

It will be seen as a technical problem to realize the significance of, the advantages associated with and/or the technical measures that will be required with respect to the arrangement incorporating that a computer related evaluation is usable by imaging an object in a medical, in a research, in an industrial, and/or in a civil and military surveillance monitoring.

It will also be seen as a technical problem to realize the significance of, the advantages associated with and/or the technical measures that will be required with respect to an arrangement incorporating said evaluation adapted to a visible light, to an UV-light, to an IR-light and/or to a THz-radiation.

It will be seen as a technical problem to realize the significance of, the advantages associated with and/or the technical measures that will be required with respect to the arrangement incorporating small lens elements, situated over and adjacent to said opto-electric transforming means, and supported by a partly or fully radiation transmitting layer.

It will be seen as a technical problem to realize the significance of, the advantages associated with and/or the technical measures that will be required with respect to the arrangement incorporating a radiation transmitting layer, built up of at least two fully or partly light transmitting sub-layers, said sensitive layer being patterned so that under each lens element there exists at least more than one opto-electric transforming means, adapted to be mutual or individual affected by said radiation.

It will be seen as a technical problem to realize the significance of, the advantages associated with and/or the technical measures that will be required with respect to the arrangement incorporating said individual lens elements, formed from a transparent material, formed and shaped in order to function as one or more focusing elements.

It will be seen as a technical problem to realize the significance of, the advantages associated with and/or the technical measures that will be required with respect to the arrangement incorporating that a partly or fully transmitting layer or coordinated sub-layers, consists of a homogenous and/or hetero-genous material.

It will be seen as a technical problem to realize the significance of, the advantages associated with and/or the technical measures that will be required with respect to the arrangement incorporating that said material is formed as a layer, consisting of fibre, spacer or a fluid or any combination thereof, being malleable by changing its volume, spacing, curvature and/or other shape changes of chemistry.

It will be seen as a technical problem to realize the significance of, the advantages associated with and/or the technical measures that will be required with respect to the arrangement incorporating that a focusing function, or a similar function, in said lens element, any light filtering, optical correction and/or zooming, is achieved by fluidic, capillary forces, molecular rearrangements and/or chemistry and/or nano-sized levers or fibres, to adjust size and/or refractive property of each lens element.

It will be seen as a technical problem to realize the significance of, the advantages associated with and/or the technical measures that will be required with respect to the arrangement incorporating that an optical element is composed of different layers of refractive material, adapted to enabling radiation at different wave-lengths to be manipulated during a path through said optical element and its lens element.

It will be seen as a technical problem to realize the significance of, the advantages associated with and/or the technical measures that will be required with respect to the arrangement incorporating that said lens element is adapted to compensate for chromatic aberration effects etc. in accordance with the art of such radiation control by an adapted choice of the used lens element material.

It will be seen as a technical problem to realize the significance of, the advantages associated with and/or the technical measures that will be required with respect to the arrangement incorporating that said material and its malleability of each lens element exposes a property or properties that causes them to be capable of a focusing effect, a zooming effect, a light filtering effect and/or an optical aberration correction effect.

It will be seen as a technical problem to realize the significance of, the advantages associated with and/or the technical measures that will be required with respect to the arrangement incorporating that an electronic signal and/or electronic signals generated are monitored and/or manipulated by means of an electronic digital processing in order to form an adapted electronic read-out signal.

It will be seen as a technical problem to realize the significance of, the advantages associated with and/or the technical measures that will be required with respect to the arrangement incorporating that an image enhancing processing algorithm or algorithms is used for overlapping received information from physically (geometrically) and/or electronically defined arrays of sensor elements or sectors, in order to obtain a high resolution image.

It will be seen as a technical problem to realize the significance of, the advantages associated with and/or the technical measures that will be required with respect to the arrangement incorporating that each of a number of individual optical element and/or a group of such elements are arranged for causing different spatial viewpoints, whereby multiple information from electronically and/or geometrically defined sectors of an array of optical elements, e.g. left and right elements, are processed to obtain a 3-D or stereotypic image.

It will be seen as a technical problem to realize the significance of, the advantages associated with and/or the technical measures that will be required with respect to the arrangement incorporating that one or more sub-layers of a partly or fully transmitting layer are arranged as a shutter layer and/or a light filter layer and formed with small dimensions, barely visible to ordinary vision.

It will be seen as a technical problem to realize the significance of, the advantages associated with and/or the technical measures that will be required with respect to the arrangement incorporating that said apparatus is attached to and/or incorporated into a large micro-sized or nano-sized device or devices, such as a credit card, a button, a pin, a medical device etc.

It will be seen as a technical problem to realize the significance of, the advantages associated with and/or the technical measures that will be required with respect to the arrangement incorporating that said optical element, used in a sensor or a digital camera, is made out of a flexible material.

It will be seen as a technical problem to realize the significance of, the advantages associated with and/or the technical measures that will be required with respect to the arrangement incorporating that said optical elements are arranged cylindrically, as on a flexible tape, and/or spherically to achieve one or more wide angle views.

It will be seen as a technical problem to realize the significance of, the advantages associated with and/or the technical measures that will be required with respect to the arrangement incorporating that said information, related to wide angle views, is caused by curving arrays of optical elements in a 2-dimensional fashion, combined with stitching available information together.

It will be seen as a technical problem to realize the significance of, the advantages associated with and/or the technical measures that will be required with respect to the arrangement incorporating that said curving of said arrays of optical elements is causing a panoramic imaging, such as up to 360°.

It will be seen as a technical problem to realize the significance of, the advantages associated with and/or the technical measures that will be required with respect to the arrangement incorporating that said information is used for wide angle view detection by spherizing arrays of optical elements in a 3-D fashion combined with stitching information together, such as producing a full 360° “fish-eye” imaging.

It will be seen as a technical problem to realize the significance of, the advantages associated with and/or the technical measures that will be required with respect to the arrangement incorporating that an image processing is used for the production of photographical projections, i.e. circular rectilinear or other flat map projections.

It will be seen as a technical problem to realize the significance of, the advantages associated with and/or the technical measures that will be required with respect to the arrangement incorporating that a colour imaging and a spectroscopic imaging is achieved by utilizing equally sized focusing lens elements and using a multi-wave-length radiation sensitive layer below focusing lens elements.

It will be seen as a technical problem to realize the significance of, the advantages associated with and/or the technical measures that will be required with respect to the arrangement incorporating that any spectroscopic imaging and/or spectroscopy is taking advantage of the optical properties of used nano-scaled lenses, by controlling the diameter of the lens elements at a nano-level.

It will be seen as a technical problem to realize the significance of, the advantages associated with and/or the technical measures that will be required with respect to the arrangement incorporating that various wave-lengths below diffraction limit is accepted.

It will be seen as a technical problem to realize the significance of, the advantages associated with and/or the technical measures that will be required with respect to the arrangement incorporating that stepwise sized lens elements, with gradually increasing/decreasing diameters are employed by utilizing processing to remove the cumulative component of the incrementally larger lens element.

It will be seen as a technical problem to realize the significance of, the advantages associated with and/or the technical measures that will be required with respect to the arrangement incorporating that a smallest diameter of a used lens element being capable of admitting only UV-light-waves and a largest diameter of a used lens element being capable of admitting all wave-lengths up to IR-radiation.

It will be seen as a technical problem to realize the significance of, the advantages associated with and/or the technical measures that will be required with respect to the arrangement incorporating that a colour imaging is achieved by controlling the diameter of a limited set of two, three or more adjacent lens elements at nano-level.

It will be seen as a technical problem to realize the significance of, the advantages associated with and/or the technical measures that will be required with respect to the arrangement incorporating that lens elements with different diameters are used to detect discrete wave-lengths, which subsequently additively combined causes conditions to produce a colour code, such as for a standard (e.g RGB, OMYK) or a false colour processing.

It will be seen as a technical problem to realize the significance of, the advantages associated with and/or the technical measures that will be required with respect to the arrangement incorporating that an electronic read-out signal is electronically processed and delivered to further imbedded processing and storage circuitry, in order to deliver information to further imbedded processing and storage circuitry or to deliver information to a separate or remote device, which in itself stores information that can be observed, stored and/or re-delivered/re-broadcast.

It will be seen as a technical problem to realize the significance of, the advantages associated with and/or the technical measures that will be required with respect to the arrangement incorporating that a multiple of cameras are distributed in space and connected to each other and/or to a central processor, enabling retrieval of multiple information.

It will be seen as a technical problem to realize the significance of, the advantages associated with and/or the technical measures that will be required with respect to the arrangement incorporating that said information is assembled inter-ferometrically, such as a large radio telescope array or to create multiple viewpoints, seeing around one or more obstacles.

It will be seen as a technical problem to realize the significance of, the advantages associated with and/or the technical measures that will be required with respect to the arrangement incorporating that said information is used as a tracking device, enabling a full 3-dimensional capability as well as a “measuring station”, adapted for performing a true 3-dimensional metric determination of an unknown object.

### Solution

The present invention takes as its starting point the known technology defined in the preamble of the accompanying claim 1, in which is stated said known arrangement adapted to evaluate the spectral intensity of and/or any changing in the spectral intensity of an electro-magnetic beam or bundle of beams, whereby said bundle of beams is directed towards and received by a lens element.

The present invention is intended to solve one or more of the above mentioned technical problems in that the invention suggests that a multitude of, adjacent each other oriented, transparent for light properties exposing, lens elements, expose dimensions adapted within a sub-micron scale and that at least one of said opto-electric transforming means is arranged adjacent to said lens element.

Suggested embodiments falling within the scope of the present invention lies in that the arrangement can be used as a sensor element within a sensor equipment as well as a digital photography and imaging apparatus, named camera equipment and may expose the features stated in the subclaims.

### ADVANTAGES

Those advantages that can be considered characteristic of the present invention and that are achieved by means of the particular characteristic features of the invention reside in the creation of a sensor equipment, a camera equipment or the like, where the over-all dimensions are kept low through introducing very small lens elements, adapted to directly radiate received radiation, such as light beams or bundle of beams, towards a multitude of small opto-electric transferring means.

Each lens element is to be dimensioned with a diameter less than 10⁻⁶ m and practically larger than 10⁻⁹ m.

### BRIEF DESCRIPTION OF THE DRAWINGS

Some embodiments of the invention at present preferred and comprising characteristic features, significant of the inventive idea, will now be described by way of examples with reference to the accompanying drawings in which:

FIG. 1 is a schematic illustration of a sensor equipment with a first arrangement of relevant function blocks,

FIG. 2 is a schematic illustration of a sensor equipment with a second arrangement of relevant function blocks,

FIG. 3 is a schematic illustration of a sensor equipment adapted for a digital camera application or equipment,

FIG. 4 is a simplified illustration of an array of optical elements and/or sensor equipments, with its respective lens element, fully or partly radiation transmitting layer with two sub-layers and a multitude of opto-electric transforming means arranged under its lens element and further said figure exposes an illustration of a space orientated camera equipments.

### DESCRIPTION OF EMBODIMENTS AT PRESENT PREFERRED

It is pointed out initially that we have chosen to use in the following description of embodiments that is at present preferred and that includes characteristic features significant of the present invention and illustrated in the figures of the accompanying drawings, special terms and terminology with the primary intention of illustrating the inventive concept more clearly. It will be noted, however, that the expressions chosen here shall not be seen as limited solely to the chosen terms used in the description but that each term chosen shall be interpreted as also including all technical equivalents that function in the same or at least essentially in the same way so as to achieve or essentially achieve the same purpose and/or technical effect.

It will be understood that the invention is not restricted to the embodiments described hereinunder by way of example, and that modifications can be made within the scope of the inventive concept illustrated in the accompanying claims.

It will be understood in particular that each illustrated unit and/or each illustrated circuit and/or equipment can be combined with each other illustrated unit and/or each illustrated circuit and/or equipment within the framework of enabling a desired technical function to be achieved.

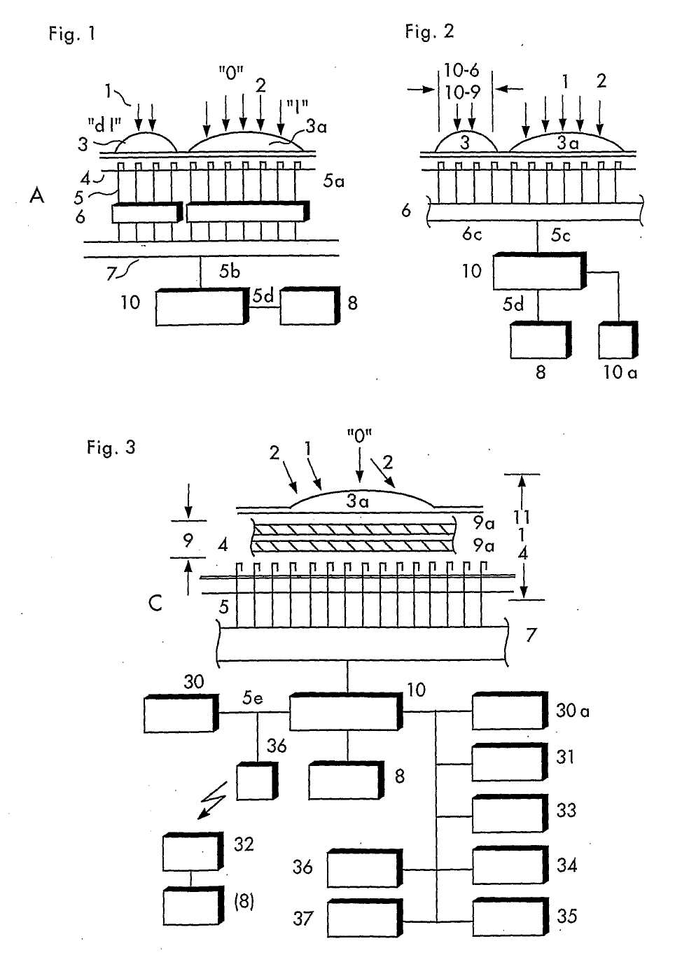

Thus FIG. 1 is illustrating a first embodiment of a sensor equipment and FIG. 2 is illustrating a second embodiment of a sensor equipment, where both equipments may be used, with smaller amendments, in a digital camera equipment or arrangement.

FIGS. 1 and 2 do illustrate some alternatives in collecting and distributing received electro-signals from a multitude of opto-electric transforming means and processing said electric signals in a processing unit for causing or forming a sensor equipment “A” in FIG. 1 and a sensor equipment “B” in FIG. 2.

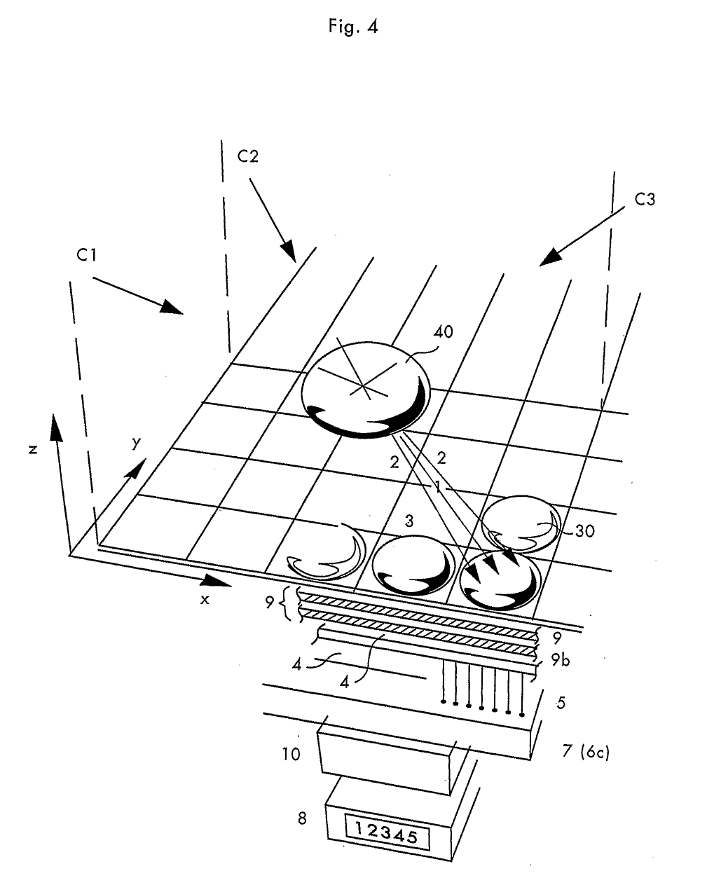

In FIG. 3 it is illustrating a collection and distribution of received electro-signals from a multitude of opto-electric transforming means and processing said electric signals in a processing unit for causing or forming a sensor equipment “C” adapted for an application in a digital camera equipment.

The thus illustrated arrangement is adapted to evaluate the spectral momentary intensity “I” of and/or a changing “dI” in the spectral intensity of an electro-magnetic beam 1 or bundle of beams 2, whereby said bundle of beams is directed towards and received by a lens element 3 and where said element 3 is adapted to direct said bundle 2 of beams towards a multitude of electro-magnetic beam to an electric signal transforming means 4, named as opto-electric transforming means 4a, said means adapted to generate an electric signal 5 representative to said spectral intensity of or said changing in said spectral intensity of said beam.

A multitude of lens elements, here illustrated with only two elements 3, 3a, expose dimensions adapted within a sub-micron scale and that at least one of said opto-electric transforming means 4 is arranged adjacent to said lens element 3.

The illustrated number of connectors related to the electric signal 5 is not significative for the present invention as much more connectors are used.

Adapted as a digital photography and imaging apparatus said electro-magnetic beam 1 or bundle of beams 2, shown in FIG. 3, are adapted to be used in a photographic camera technology, which will be described more in detail hereinunder.

For this application and also sensor application the electric signals 5 from each of the means 4 are coordinated within a circuit 6.

FIG. 1 illustrates that one such circuit 6a is related to the lens element 3 and one circuit 6b is related to the lens element 3a exposing different dimensions and different connectors.

In FIG. 2 it is illustrated that a circuit 6c is related to both lens elements 3 and 3a.

FIG. 1 illustrates the use of a further circuit 7 before the signals 5 are processed and evaluated in a processing unit, illustrated as a computer CPU and given the reference numeral 10, and the result is transmitted to a display or information unit 8.

Said evaluation is usable by imaging an object “0” in a medical, in a research, in an industrial, and/or in a civil and military surveillance monitoring.

Said evaluation is adapted to a visible light, to an UV-light, to an IR-light and/or to a THz-radiation dependent upon material used in the lens elements 3, 3a, the partly or fully transmitting layer 9 and the used opto-electric transforming means 4.

In FIGS. 1, 2 and 3 said lens elements 3, 3a are situated over and adjacent to said opto-electric transforming means 4 and supported by a partly or fully radiation transmitting layer 9.

Said radiation transmitting layer 9 is built up of at least two fully or partly radiation or light transmitting sub-layers 9a and 9b, said sensitive layer being patterned so that under each lens element 3a there exists at least more than one opto-electric transforming means 4, adapted as to be mutual or individual affected by said radiation “I”.

It is here to be noted that the sensor equipment or the used optical element 3, 3a may be wave-length dependent, where the wave-length may be chosen in dependency of the chosen shape of the lens element 3, 3a, the shape and property of the partly or fully transmitting layer 9, with its sub-layers 9a, 9b and the chosen opto-electric transforming means 4 on a radiation sensitive layer 4′.

Said individual lens elements, one designated 3a in FIG. 3, are formed from a transparent material, formed and shaped in order to function as one or more focusing elements.

Said partly or fully transmitting layer 9 consists of a homogenous and/or hetero-genous material.

Said material is formed as a layer, either layer 9a or layer 9b alternative as well layer 9a as layer 9b, consisting of fibre, spacer or a fluid or any combination thereof, being malleable by changing its volume, spacing, curvature and/or other shape changes of chemistry.

Said focusing function in said lens element 3a, any light filtering, any optical correction and/or any zooming effect, are achieved by fluidic, capillary forces, molecular rearrangements and/or chemistry and/or nano-sized levers or fibres to adjust size and/or refractive property of the lens element 3a.

Said lens element 3a may be composed of different layers of refractive material, adapted to enabling radiation at different wave-lengths to be manipulated during a path through said optical element “C”.

Said lens element 3a is further adapted to compensate for chromatic aberration effects etc. in accordance with the art of such radiation control by adapted choice of lens material.

Said material and its malleability of each lens element 3a exposes a property or properties that causes them to be capable of a focusing effect, a zooming effect, a light filtering effect and/or an optical aberration correction effect.

An electronic signal 5a and/or electronic signals 5b, 5c generated are monitored and/or manipulated by means of electronic digital processing 10 in order to form an electronic read-out signal 5d.

Said digital processing means 10 are in FIG. 2 related to a programming, illustrated as a block 10a.

An image enhancing processing algorithm or algorithms 31 is in FIG. 3 used for overlapping received information from physically (geometrically) and/or electronically defined arrays of sensor elements 3, 3a or sectors in order to obtain a high resolution image.

FIG. 3 illustrates that the used data program is divided into two sections 30 and 30a, where the programming block 30 illustrates a known soft-ware to process information from a number of lens elements and opto-electronic transforming means with larger dimensions than the used dimensions according to the present invention to form a 2-D or a 3-D image of an object and the present invention suggests an additional programming block 30a in order to process received electric signals from the opto-electronic transforming means into information adapted to the programming block 30.

Each of a number of individual optical elements 3 or 3a and/or a group of such elements 3, 3a are arranged for causing different spatial viewpoints, whereby multiple information from electronically and/or geometrically defined sectors of an array of optical elements, e.g. left and right elements, are processed to obtain a 3-D or stereotypic image.

Used in a digital camera equipment one or more sub-layers 9a and 9b of a partly or fully transmitting layer 9 are arranged as a shutter layer (9a) and formed with small dimensions, barely visible to ordinary vision.

Said small apparatus or equipment can be incorporated into a large micro-sized or nano-sized device or devices, such as a credit card, a button, a pin, a medical device etc.

According to the present invention said camera equipment “C” related optical elements are made out of a flexible material.

According to one aspect of the present invention said optical elements, including said lens element 3, a number of opto-electric transforming means 4 and intermediate oriented partly or fully light transmitting layer 9, with its sub-layers 9a and 9b, are arranged cylindrically, as on a flexible tape, and/or spherically to achieve one or more wide angle views.

Information related to wide angle views is caused by curving arrays of optical elements in a 2-dimensional fashion, combined with stitching information 33.

Said curving of said arrays of optical elements “C” is causing a panoramic imaging, such as up to 360°.

Said information is used for wide angle view detection by spherizing arrays of optical elements in a 3-D fashion combined with stitching information together, such as producing a full 360° “fish-eye” imaging.

An image processing 34 is used for the production of photographical projections, i.e. circular rectilinear or other flat map projections.

A colour imaging and a spectroscopic imaging is achieved 35 by utilizing equal sized focusing lens elements 3, 3a and using a multi-wave-length radiation sensitive layer 4 below focusing lens elements 3, 3a.

Any spectroscopic imaging and/or spectroscopy is taking advantage of the selected optical properties of used nano-scaled lenses by controlling the diameter of the lens elements at a nano-level.

Various wave-lengths below diffraction limit is thus accepted.

Stepwise sized lens elements 3, 3a with gradually increasing and/or decreasing diameter are employed by utilizing processing to remove the cumulative component of the incrementally larger lens element.

A smallest diameter of a lens element 3 being capable of admitting only UV-light waves and a largest diameter of a lens element 3a being capable of admitting all wave-lengths up to IR-radiation.

A colour imaging is achieved by controlling the diameter of a limited set of two, three or more adjacent lens elements 3, 3a at nano-level.

Lens elements 3, 3a with different diameters are used to detect discrete wave-lengths, which subsequently additively combined causes conditions to produce a colour code for a standard (e.g. RGB, OMYK) or a false colour processing.

An electronic read-out signal 5e is electronically processed and delivered to further imbedded processing and storage circuitry 36, in order to deliver information to further imbedded processing and storage circuitry or to deliver information wireless to a separate or remote device 32, which in itself stores information that can be observed, stored and/or re-delivered and/or re-broadcast.

A multiple of camera equipments “C1”, “C2” and “C3” are distributed in space in FIG. 4 and connected to each other and/or to a central processor 10, (not shown in FIG. 4) enabling retrieval of multiple information related to a boll related object 40.

Said information is assembled inter-ferometrically in a function 36, such as a large radio telescope array or to create multiple viewpoints, seeing around one or more obstacles 40.

Said information is used as a tracking device or function 36, enabling a full 3-dimensional capability as well as a “measuring station”, adapted for performing true 3-dimensional metric determination of an unknown object 40.

It is to be noted that the evaluation of a change in an image need circuits for storing the image and circuits for evaluating any change in said stored image, however these circuits are not illustrated.

It is also to be noted that the evaluation of a chosen intensity level need a reference value stored and this memory is not illustrated in the shown embodiments.

Such circuits and such memories may be related to the processing unit 10 and is in FIG. 4 schematically illustrated as a block 37.

Moreover, FIG. 4 illustrates how two diverging beams or a bundle of beams 2, 2′ are directed to the lens element 3a and that different opto-electric transforming means 4 is actuated with different intensities.

The same beams 2, 2′ will actuate different opto-electric transforming means 4 under the lens element 3 and so on, which means that the position of object 40 can be evaluated in the processing device 10.

FIG. 4 also indicates that a multitude of additional lens elements are distributed in an “x”/“y”-coordinate system and that sensor equipments “C1”, “C2” and “C3” are orientated in the “z”-coordinate direction.

1. An arrangement adapted to evaluate the spectral intensity (I) of an/or a changing (dI) in the spectral intensity of an electro-magnetic beam (1) or a bundle (2) of beams, whereby said beam or bundle of beams is directed towards and received by a lens elements (3, 3a) and where said lens element is adapted to direct said beam or bundle of beams towards a multitude of electro-magnetic beam to an electric signal transforming means (4), names as opto-electric transforming means, said means adapted to generate an electric signal (5) representative to said spectral intensity of or said changing in said spectral intensity of said beam (1) or bundle (2) of beams, characterized in, that a multitude of lens elements (3,3a) are exposing dimensions adapted within a sub-micron scale (10⁻⁶ m), and that at least one of said opto-electric transforming means (4) is to be arranged adjacent to said lens element (3,3a) and said evaluation is adapted to and based on the use of a visible light, an UV-light, an IR-light and/or a THz-radiation.

2-34. (canceled)
